(19) United States
(12) Patent Application Publication
(10) Pub. No.: US 2018/0170164 A1
(43) Pub. Date: Jun. 21, 2018

(54) Neoprene Protective Covers for Vehicles and Other Objects

(71) Applicant: Kate Wingard, Denver, CO (US)

(72) Inventor: Kate Wingard, Denver, CO (US)

(21) Appl. No.: 15/846,193

(22) Filed: Dec. 18, 2017

Related U.S. Application Data
(60) Provisional application No. 62/437,654, filed on Dec. 21, 2016.

(51) Int. Cl. B60J 11/00; B32B 37/10; B32B 37/06; B32B 27/08

(52) U.S. Cl. CPC B60J 11/00; B32B 37/10; B32B 2605/00; B32B 27/08; B32B 37/06

(57) ABSTRACT

The invention encompasses novel protective covers for vehicles and other metal objects. The novel protective covers comprise one or more sheets of neoprene, providing outstanding protective properties. The covers may be attached to metal surfaces such as automobiles by integral magnets. The invention also encompasses novel methods of joining neoprene sheets by welding, and objects made by said method.

### CROSS-REFERENCE TO RELATED APPLICATIONS

This application is based on and claims the benefit of priority of U.S. Provisional Patent Application Ser. No. 62/437,654 filed on Dec. 21, 2016, entitled “Protective Cover for Vehicles,” the contents of which are incorporated by reference.

### BACKGROUND OF THE INVENTION

During transport, repair, and storage of vehicles, it is desirable to protect the exterior surfaces from scratches, dings, dents, or other damage. Vehicle owners need an effective and versatile means to preserve the integrity and aesthetics of paint and metal surfaces, as well as to maintain the commercial value of their vehicles.

One solution that has been proposed is the use of pads, panels, or other coverings comprising magnets, wherein the pad can attach to the surface of a metal vehicle, held in place by magnetic forces. For example, a magnetic car covering is described in United States Patent Application Publication Number 200702016193, by Webber, entitled “Car Cover and Car Cover Deployment System”; U.S. Pat. No. 3,910,330, by Johnson and Johnson, entitled “Portable Vinyl Auto Top Cover”; United States Patent Application Publication Number 20150001838, by Moroz, entitled “Magnetic Vehicle Body Panel Protector”; and United States Patent Application Publication Number 20060243767, by McMillin, entitled “Magnetic Pad.”

The prior devices for protection of vehicles comprise materials such as vinyl, polypropylene, polyethylene, or a magnetized material.

While the prior devices for protection of vehicles are adequate for some applications, there remains a need in the art for protective devices that can be used in the auto repair business. Such pads would advantageously be waterproof, fireproof or flame resistant, non-scratching, durable, and provide substantial padding.

### SUMMARY OF THE INVENTION

Provided herein are novel devices for the protection of automobiles. The devices of the invention utilize a novel material for vehicle covers, neoprene. The neoprene pads and covers of the invention provide superior protection, being soft, non-scratching, durable, and flame resistant. The neoprene pads of the invention are utilized with magnets to enable facile attachment to automobiles and other metal surfaces.

Furthermore, present disclosure provides the art with a novel composition of matter in the form of welded neoprene. The novel welding of neoprene disclosed herein may be further employed in other contexts to create unique products.

### BRIEF DESCRIPTION OF THE DRAWINGS

FIG. 1A depicts a perspective view of a welded neoprene protective cover of the invention. FIG. 1B depicts a cutaway diagram of the welded neoprene protective cover.

FIG. 2 depicts an exemplary protective car cover of the invention deployed on a car. The body of the cover (201) is held to the car (205) by integral magnets (203). A plurality of cells in a grid pattern (202) provide cushioning. Graphics for branding (204) are present on the cover.

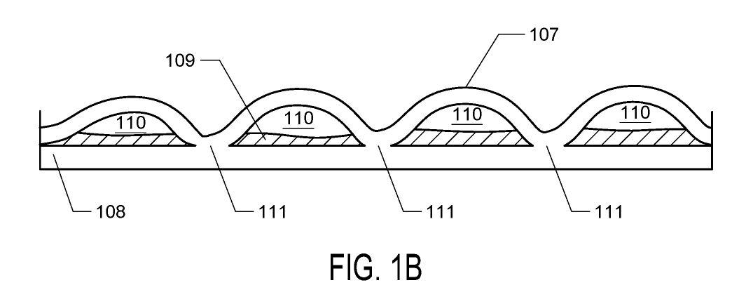

FIG. 3 depicts an exemplary protective car cover deployed to protect the tailgate of a pickup truck. The body of the cover (301) is held to the tailgate of the truck (305) by integral magnets (303). A plurality of cells in a grid pattern (302) provide cushioning. Graphics for branding (304) are present on the cover.

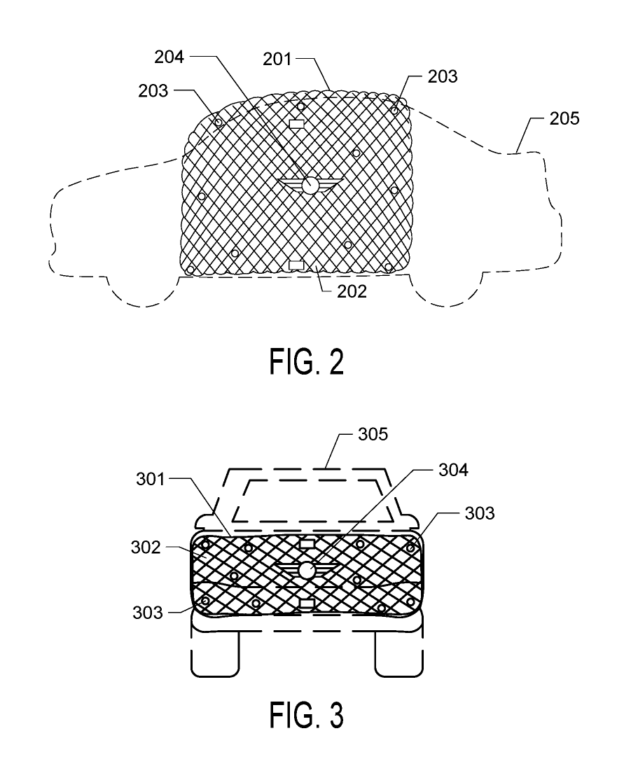

FIG. 4 depicts an exemplary protective car cover of the invention deployed on the roof of a car. The body of the cover (401) is held to roof of the car (405) by integral magnets (403). A plurality of cells in a grid pattern (402) provide cushioning. Graphics for branding (404) are present on the cover.

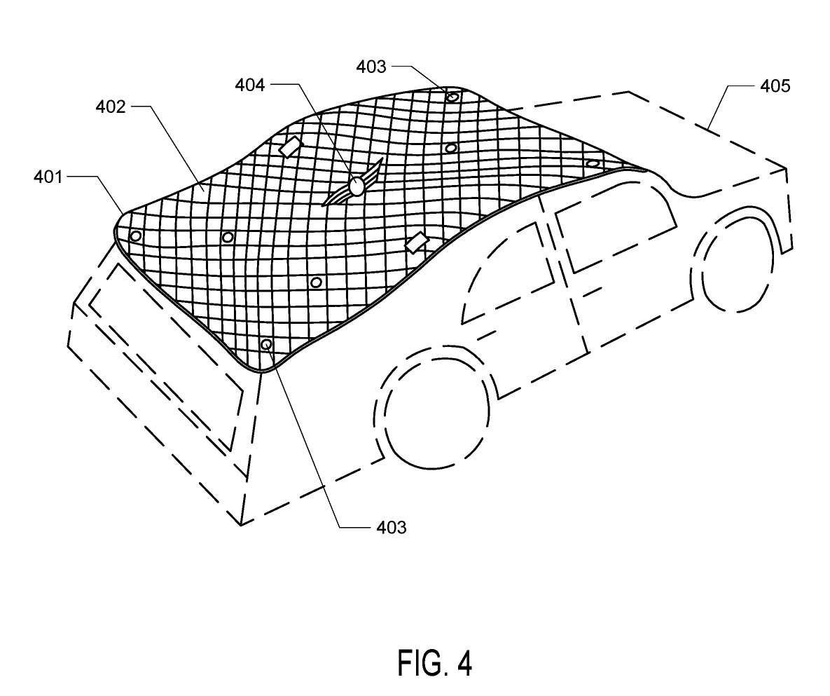

### DETAILED DESCRIPTION OF THE INVENTION

The scope of the invention encompasses various pads, mats, covers, and other protective items. The various elements of the invention are described in detail next.

### Body.

The covering comprises a body which is essentially flat. The covering comprises neoprene material. Within the body, a plurality of magnets are present, which enable the covering to be adhered to a metal surface. The covering may be applied to various metal surfaces in need of protection, including vehicles.

The body of the covering comprises one or more sheets of neoprene. Neoprene, as known in the art, comprises any material comprising a polymer of chloroprene. Neoprene in rubber or latex forms, as known in the art, may be used.

Neoprene advantageously protects the surface from heat, flame and/or spark, for example, heat derived from auto body work and maintenance and/or engine heat. Neoprene material is a flame retardant material that combats and self-extinguishes flame and contains heat transfer in a protective manner so as to reduce the spread of flame. Neoprene is also highly water-resistant. Another advantage of neoprene is its durability, as it is hard to tear, cut, or puncture, thereby creating long-term wear and tear resistance. The neoprene is also pliable and soft with a rubber and/or rubber—like core that prevents the material from being crushed and acts as a cushion to protect the exterior surfaces it is laid upon from being dented, damaged, or scratched. Neoprene material is also suitable for outdoor use, which is a necessary requirement for automotive protection functions.

Neoprene is manufactured outside of North America due to strict U.S. manufacturing regulations. While neoprene has been adopted in a number of applications, to the knowledge of the inventor of the present disclosure, neoprene has not previously been used in the field of exterior automotive protection. Very few manufacturers within the U.S. are able to properly cut neoprene due to its difficult material construction. Special machines are required to cut neoprene without distressing, and/or fraying the fabric.

The neoprene devices of the invention may comprise one or more neoprene sheets of any thickness, for example, in the range of 1-10 mm in thickness. A thickness of 5 mm, for example, provides substantial cushioning while retaining flexibility. The covering may comprise one sheet of neoprene, or multiple sheets of neoprene sewn, adhered, or otherwise fastened together in layers. The covering may further comprise one or more additional layers of non-neoprene material as an inner, outer, or intermediate layer.

The covering may be cut into any shape desired. In one embodiment, the covering is a rectangle. In another embodiment, the covering comprises a square. In other implementations, multiple pieces of body material are cut and sewn or otherwise fastened to create a covering that will conform to a complex three dimensional shape, such as a car cover. In another embodiment, the covering comprises a piece that substantially conforms to the metallic object which it it intended to protect, for example, a car door, tailgate, body panel, or other vehicle part.

In one embodiment, the invention comprises two neoprene sheets which are quilted together, for example in a cross-hatched stitching pattern.

The joined neoprene sheet may comprise a peripheral edging or hemming to prevent fraying.

### Welded Neoprene.

In one embodiment, the vehicle pad of the invention comprises two sheets of neoprene joined by welding. In welding of neoprene, a hot tool is applied with significant pressure to two sheets of neoprene layered on top of one another, with a solid backing. The heat melts the neoprene sheets and the pressure fuses them together. In a preferred implementation, the heated tool comprises a metal bar, or grid, for example comprising square or substantially square metal, for example, being 1-15 mm in width, which may comprise a metal such as aluminum, magnesium, or brass. The bar should be heated to a temperature above that of the melting point of neoprene, for example in the range of 70-180° C. The bar can be applied with pressure, for example 20-500 pounds per square inch pressure. For example, in one embodiment, 10-200 kilowatts of pressure per square foot of fabric is utilized, for example 15 or greater kilowatts. The pressure is applied for a time sufficient to melt the neoprene layers together, for example 5-30 seconds.

The welded neoprene sheets of the invention may comprise an intermediate layer, for example a polyether material or polyester material, polyvinyl material or other polymeric material. For example, the intermediate layer may comprise a material having a melting point similar to that of neoprene, for example in the range of 70-110° C. The function of such material is to act as a flux which melts into the melted neoprene and provides additional strength to the welds. Exemplary materials include 0.5-2 mm thick sheets of polyether, polyester, or polyvinyl material.

The scope of the invention encompasses a method of welding neoprene, as described above, and further extends to any item comprising welded neoprene, i.e. any item comprising two sheets of neoprene material fused together by the application of heat and pressure.

In the context of vehicle protection, in one embodiment, the invention comprises two sheets of neoprene welded together in a criss-crossed or grid pattern such that individually sealed cells of neoprene are formed. Air pockets may be allowed to form passively during the manufacturing process, for example by tenting or rippling the material such that air is present between the layers. Alternatively, air or other gases may be injected into the cells by a hollow welding tool comprising a nozzle or outlet port that introduces air or other gas between the sheets of neoprene to form bubbles during the welding. When air or other gas is present within the sealed cells, each cell becomes a separate padding unit, as in bubble wrap. The bubbles of the individually sealed cells provide additional padding properties to the vehicle pads of the invention.

### Magnetic Elements.

The covering will further comprise one or more magnets. These magnetic elements are present at various locations around the covering. For example, the magnets may be spaced around the perimeter of the body. In another embodiment, the magnets are placed in a regular pattern, such as an X-Y grid pattern.

The magnets may be integrated into the body of the covering in any manner. In a preferred implementation, the magnets are sewn or welded into individual pockets formed between the layers of the body, such that they are encased. Alternatively, the magnets may be covered by a patch of material and the patch being adhered, sewn or welded to the body. Magnets may also be external to the body, being sewn, fused, or adhered thereto. In a preferred implementation, the magnets are substantially flat (e.g. discs or squares) to maintain a low profile. Any type of magnet may be used, including ceramic magnets, iron magnets, or powerful rare earth magnets such as neodymium magnets.

Magnets can be present in any amount, preferably in such amount sufficient to support the weight of the cover in a lateral position, i.e. against gravity. For example, at least 2-6 pounds of magnetic pull per square foot of fabric may be used, for example about 4 pounds per square foot.

In an alternative implementation, the magnets are omitted and the covers can be applied to the target surface by other means, such as gravity (i.e. the covers lie upon the surface) or being secured by ties or straps.

### Graphics.

A further objective of this invention is to provide a surface for the application of a decorative visual design, logo, brand image, or other graphics. One or more portions of the body of the covering may comprise a graphic element. The graphic element may be applied by way of digital printing, laser printing, heat transfer printing, dye sublimation, label printing, puff ink printing, watermark printing, silkscreen printing, offset printing, or color lamination. The graphic element can be displayed by adhering the covering to a metal surface, with the graphic side out. For example, the covering can act as a temporary sign that is reversibly adhered to a vehicle or other metal object.

### Exemplary Embodiment

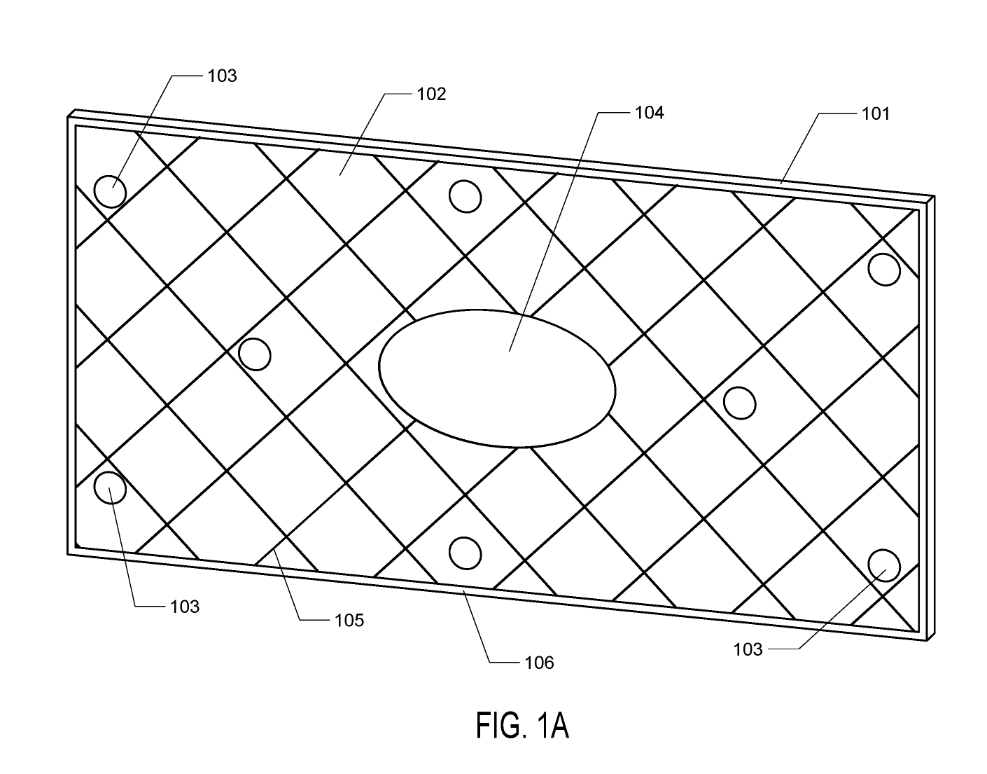

An exemplary embodiment of the invention is depicted in FIG. 1A and FIG. 1B. In this exemplary implementation of the invention, the device comprises a rectangular body (101), the rectangular body comprising a pair of stacked neoprene sheets (107 and 108), with an intermediate layer of polyether material disposed between the sheets (109). The sheets have been welded together in a grid pattern (105), creating several squares (102) which comprise cells filled with air (110), which increase the cushioning abilities of the pad. At the welds, regions are created wherein the two sheets and intermediate material are fused (111). The edge of the rectangular body has been welded or sewn around the perimeter to create a border or hem (106), to prevent separation of the sheets. The position of numerous magnets (103) appended to the body is depicted in FIG. 1A. The body of the pad comprises a space for graphics (104).

### Methods of Use.

The scope of the invention encompasses the items described above as well as methods of using such items. The magnetic coverings of the invention may be applied to any metal surface, for example, to cars (e.g. collector and vintage cars), trucks, auto body parts, trailers, boats, motorcycles, aircraft, and metal accessories and parts. The coverings of the invention may comprise additional elements which aid in the fastening of the cover to the object which it is protecting, for example straps, hooks, eyeholes, snaps, etc. However, in a preferred implementation, no additional fastening elements are utilized, so that the cover can be quickly applied to and removed from the target object with ease. Coverings having customized shapes may be utilized to protect the aforementioned items, or sections thereof. The coverings of the invention may be applied during transport, repair, or storage of item to be protected. Advantageously, the neoprene body of the coverings of the invention provides superior protection against dents, scratches, and dings, from human error and also protection from the elements, including UV light, water, etc. The covers may advantageously be used in repair shops and garages to keep parts safe from abrasions. The covers may also be used during transport, indoor/outdoor parking, and storage.

All patents, patent applications, and publications cited in this specification are herein incorporated by reference to the same extent as if each independent patent application, or publication was specifically and individually indicated to be incorporated by reference. The disclosed embodiments are presented for purposes of illustration and not limitation. While the invention has been described with reference to the described embodiments thereof, it will be appreciated by those of skill in the art that modifications can be made to the structure and elements of the invention without departing from the spirit and scope of the invention as a whole.

What is claimed is:

1. A covering for the protection of metal objects, comprising
one or more sheets of neoprene; and
a plurality of magnets adhered to or sewn onto or between the one or more sheets of neoprene.

2. The covering of claim 1, wherein
the shape of the covering is that of a square, rectangle, or car cover.

3. The covering of claim 1, wherein
the body comprises two stacked sheets of neoprene sewn together.

4. The covering of claim 1, wherein
the body comprises two stacked sheets of neoprene welded together.

5. The covering of claim 4, wherein
the body further comprises a sheet of polymeric material disposed between the two neoprene sheets.

6. The covering of claim 4, wherein
the sheets are welded in a grid pattern such that a plurality of individually sealed cells are present.

7. The covering of claim 6, wherein
pockets of air or another gas are present in the individually sealed cells.

8. A method of using a covering to protect a metal object,
wherein the covering comprises one or more sheets of neoprene and magnets attached to or encased within the one or more neoprene sheets, the method comprising
applying the covering to a metal object.

9. The method of claim 8, wherein
the metal object is selected from the group consisting of cars, trucks, motorcycles, trailers, aircraft, boats, and auto body parts.

10. A method of joining two or more sheets of neoprene together, comprising
applying a hot metal body to the two or more sheets of neoprene, wherein the tool has a temperature that exceeds the melting point of the neoprene, with sufficient pressure and for sufficient time for the neoprene sheets to melt and fuse.

11. The method of claim 10, wherein
the tool comprises magnesium, brass, or aluminum.

12. The method of claim 10, wherein
the tool is heated to between 60 and 200° C.

13. The method of claim 10, wherein
an intermediate layer comprising a polymeric material is disposed between the neoprene sheets.

14. The method of claim 13, wherein the intermediate layer comprises a polyether, polyester, or polyvinyl material.
